(19) United States
(12) Patent Application Publication
(10) Pub. No.: US 2017/0277001 A1
(43) Pub. Date: Sep. 28, 2017

(54) BACKLIGHT MODULE AND DISPLAY DEVICE

(71) Applicants: Le Holdings(Beijing)Co., Ltd., Beijing (CN); LE SHI ZHI XIN ELECTRONIC TECHONOLGY (TIAN JIN) LIMITED, Tianjin (CN)

(72) Inventor: Changjia FU, Tianjin (CN)

(21) Appl. No.: 15/246,452

(22) Filed: Aug. 24, 2016

Related U.S. Application Data
(63) Continuation of application No. PCT/CN2016/088972, filed on Jul. 6, 2016.

(30) Foreign Application Priority Data
Mar. 22, 2016 (CN) 201620231141.9

(51) Int. Cl. G02F 1/1335

(52) U.S. Cl. CPC G02F 1/133611; G02F 1/133603; G02F 1/133605; G02F 1/133606; G02F 2001/133607

(57) ABSTRACT

Disclosed are a backlight module and a display device. The backlight module includes a back cover including an accommodation space in which a reflector, a light component, and a diffuser plate are placed in that order, wherein the light component includes a plurality of first Light Emitting Device (LED) devices and a plurality of second LED devices, wherein the second LED devices emit light at a smaller angle than the angle at which the first LED devices emit light, the first LED devices are arranged annularly and opposite in position to the periphery of the diffuser plate, and the second LED devices are located so that they are surrounded by the first LED devices. Since the first LED devices emit light at a larger angle, more light rays thereof will be incident on the edges of the diffuser plate to thereby improve effectively the phenomenon of dark strips at the edges of a picture of the backlight module; and since the second LED devices emit light at a relatively small angle, the light rays thereof can be incident on the diffuser plate while being more concentrated to thereby improve effectively the phenomena of low brightness, shadowiness, etc., of the picture of the backlight module.

### CROSS REFERENCE TO RELATED APPLICATIONS

This application is a continuation of International Application No. PCT/CN2016/088972, filed on Jul. 6, 2016, which is based upon and claims priority to Chinese Patent Application No. 201620231141.9, filed on Mar. 22, 2016, the entire contents of which are incorporated herein by reference.

### TECHNICAL FIELD

The disclosure relates to the field of display technologies, and particularly to a backlight module and a display device.

### BACKGROUND

As the sciences and technologies are developing constantly, there are also constantly growing demands of consumers for flat panel displays, flat panel TV sets, and other display devices, and increasingly frequently renewed structures, form factors, performances, and other aspects of the display devices.

At present, Light Emitting Diodes (LEDs) are commonly applied as light sources in a backlight module of a liquid crystal display device. The backlight module can be categorized into a backlight module of straight down type and a backlight module of side light type, dependent upon the positions where the light sources are distributed, where the light sources in the backlight module of straight down type are distributed below a diffuser plate, and such a backlight module is generally applicable to a display, a TV set, or another liquid crystal display device with a large size.

Typically the brightness of a picture on the existing display device including the backlight module of straight down type is low, there is dark shadow above the LEDs, or dark strips at the edges of the LEDs, etc. In view of this, a technical problem highly desirable to be addressed by the application is how to improve the quality of the picture on the display device.

### SUMMARY

Embodiments of the application provide a backlight module and a display device so as to weaken the phenomenon of lamp shadow in the backlight module, and further improve the quality of a picture on the display device.

An embodiment of the application provides a backlight module including a back cover including a back cover including an accommodation space in which a reflector, a light component, and a diffuser plate are placed in order, wherein:

the light component includes a plurality of first Light Emitting Device (LED) devices and a plurality of second LED devices, wherein the second LED devices emit light at a smaller angle than the angle at which the first LED devices emit light, the first LED devices are arranged annularly and opposite the periphery area of the diffuser plate, and the second LED devices are located so that they are surrounded by the first LED devices.

An embodiment of the application further provides a display device including the backlight module according to any one of the technical solutions above. Since the backlight module has the advantageous effects above, the display device can have a high quality of pictures.

### BRIEF DESCRIPTION OF THE DRAWINGS

In order to make the technical solutions according to the embodiments of the application or in the prior art more apparent, the drawings to which a description of the embodiments or the prior art refers will be briefly introduced below, and apparently the drawings to be described below are merely illustrative of some of the embodiments of the application, and those ordinarily skilled in the art can derive from these drawings other drawings without any inventive effort.

One or more embodiments are illustrated by way of example, and not by limitation, in the figures of the accompanying drawings, wherein elements having the same reference numeral designations represent like elements throughout. The drawings are not to scale, unless otherwise disclosed. In the drawings:

FIG. 1 is a schematic structural diagram of a cross session of a backlight module according to some embodiments of the application;

FIG. 2 is a top view of a light component in a backlight module according to some embodiments of the application;

FIG. 3 is a schematic diagram of a first LED device; and

FIG. 4 is a schematic diagram of a second LED device.

### REFERENCE NUMERALS

1—Back cover

2—Reflector

3—Light component

4—Diffuser plate

31—First LED device

32—Second LED device

30—LED chip

311—Reflective lens

321—Refractive lens

### DETAILED DESCRIPTION

In order to make the objects, technical solutions, and advantages of the embodiments of the application more apparent, the technical solutions according to the embodiments of the application will be described below clearly and fully with reference to the drawings in the embodiments of the application, and apparently the embodiments described below are only a part but not all of the embodiments of the application. Based upon the embodiments here of the application, all the other embodiments which can occur to those skilled in the art without any inventive effort shall fall into the scope of the application.

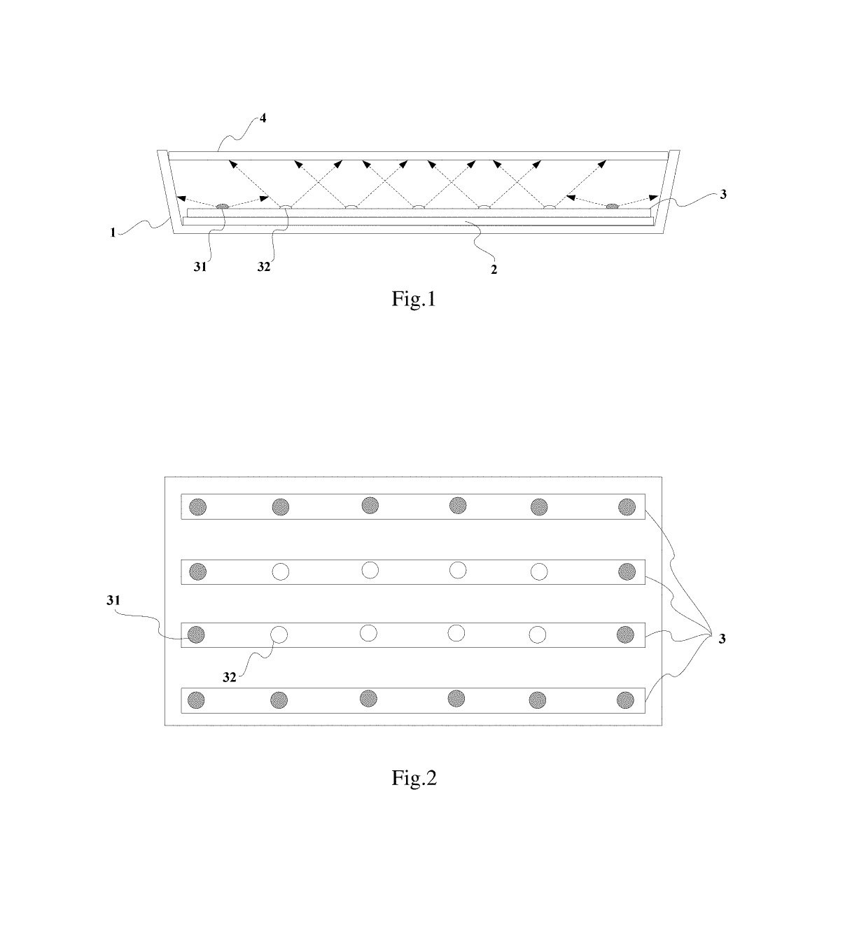

As illustrated in FIG. 1 and FIG. 2, an embodiment of the application provides a backlight module including a back cover 1 including an accommodation space in which a reflector 2, a light component 3, and a diffuser plate 4 are placed in order, where:

The light component 3 includes a plurality of first LED devices 31 and a plurality of second LED devices 32, where the second LED devices 32 emit light at a smaller angle than the angle at which the first LED devices 31 emit light, the first LED devices 31 are arranged annularly and opposite the periphery area of the diffuser plate 4, and the second LED devices 32 are located so that they are surrounded by the first LED devices 31.

The backlight module is a backlight module of straight down type, and light rays emitted by the LED devices are incident to the bottom of the diffuser plate. The LED light component generally includes a printed circuit board, and LED devices arranged on the printed circuit board. The backlight module typically includes an optical film sheet, a glue frame, and other components, none of which is illustrated, in addition to the back cover 1, the reflector 2, the light component 3, and the diffuser plate 4.

In the embodiment above, as can be appreciated, the first LED devices 31 are arranged annularly and opposite the periphery area of the diffuser plate 4 so that the orthographic projections of the first LED devices 31 onto the diffuser plate 4 are located at the region near the edges of the diffuser plate 4, and since light rays emitted by the first LED devices 31 diverge at some light emission angle, they can be incident to the periphery area of the diffuser plate 4 including the edges thereof. The second LED devices 32 located so that they are surrounded by the first LED devices 31, means that the second LED devices 32 are located inside an annulus formed by first LED devices 31.

In the technical solution according to the embodiment of the application, the first LED devices 31 are arranged annularly and opposite the periphery area of the diffuser plate 4, and since the first LED devices 31 emit light at a larger angle, more light rays thereof will be incident to the edges of the diffuser plate 4 to thereby improve effectively the phenomenon of dark strips at the edges of a picture of the backlight module; and the second LED devices 32 are located so that they are surrounded by the first LED devices 31, and since the second LED devices 32 emit light at a relatively small angle, the light rays thereof can be incident to the diffuser plate 4 while being more concentrated to thereby improve effectively the phenomena of low brightness, lamp shadow, etc., of the picture of the backlight module. The backlight module according to the embodiment of the application can be applicable to a display device to thereby improve effectively the quality of a picture on the display device.

Referring to FIG. 1, preferably each of the first LED devices 31 emits light at an angle from 150° to 170°, and each of the second LED devices 32 emits light at an angle from 90° to 120°. As illustrated in FIG. 2, the first LED devices 31 are distributed uniformly, and the second LED devices 32 are distributed uniformly. With this design, the drawback of the picture including the dark strips on the edges, the low brightness, the lamp shadow, etc., thereof can be improved, and the picture of the backlight module can be provided with good uniformity.

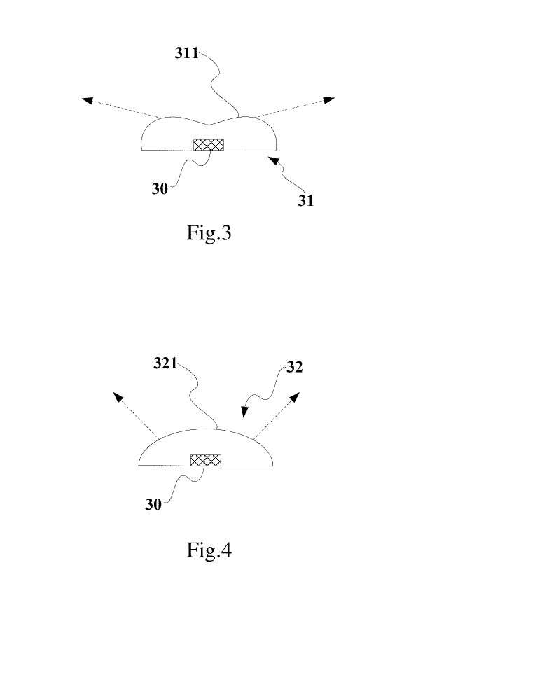

In a preferred embodiment of the application, as illustrated in FIG. 3, each of the first LED devices 31 includes an LED chip 30 and a reflective lens 311, both of which are packaged, and as illustrated in FIG. 4, each of the second LED devices 32 includes an LED chip 30 and a refractive lens 321, both of which are packaged.

Since the LED chips have a small volume, a compact structure, and a small light emission area, the optical structure of the LED devices in a particular application will be designed again dependent upon an application scenario thereof to thereby reshape and alter the light emitted by the LED chips so as to adjust the light emission angle and the light intensity distribution of the LED devices. The lens and the LED chips can be packaged to thereby alter the light emission angle, and thus the area of a light beam so as to alter the area of illumination on the surface of an illuminated object, and the value of luminance thereof.

In a preferred embodiment of the application, the first LED devices 31 include the reflective lenses 311 with surfaces thereof being recessed, and the light emitted by the LED chips 30 passing the reflective lenses 311 diverges at a larger angle so that more light rays can be incident to the edges of the diffuser plate 4 to thereby improve effectively the phenomenon of the dark strips at the edges of the picture of the backlight module. The second LED devices 32 include the refractive lens 321 with surfaces thereof being arched, and the light emitted by the LED chips 30 passing the refractive lens 321 diffuses at a smaller angle, and thus can be incident to the diffuser plate 4 while being more concentrated to thereby improve effectively the phenomena of the low brightness, the shadowiness, etc., of the picture of the backlight module.

The particular structures of the reflective lenses 311 and the refractive lens 321 will not be limited to those illustrated in FIG. 3 and FIG. 4, and their types of materials will not be limited to any particular types of materials, for example, the reflective lenses 311 can be reflective glass lenses, reflective polycarbonate lenses, reflective PMMA lenses, etc.; and the refractive lenses 321 can be refractive glass lenses, refractive polycarbonate lenses, refractive PMMA lenses, etc.

An embodiment of the application further provides a display device including the backlight module according to any one of the technical solutions above. Since the backlight module has the advantageous effects above, the display device can have a high quality of pictures. The display device will not be limited to any particular type, for example, the display device can be a liquid crystal TV set, a liquid crystal display, a liquid crystal exhibition screen, etc.

Lastly it shall be noted that the respective embodiments above are merely intended to illustrate but not to limit the technical solution of the application; and although the application has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the application as claimed.

What is claimed is:

1. A backlight module, comprising a back cover comprising an accommodation space in which a reflector, a light component, and a diffuser plate are placed in order, wherein:
the light component comprises a plurality of first Light Emitting Device (LED) devices and a plurality of second LED devices, wherein the second LED devices emit light at a smaller angle than the angle at which the first LED devices emit light, the first LED devices are arranged annularly and opposite the periphery area of the diffuser plate, and the second LED devices are located so that they are surrounded by the first LED devices.

2. The backlight module according to claim 1, wherein each of the first LED devices emits light at an angle from 150° to 170°, and each of the second LED devices emits light at an angle from 90° to 120°.

3. The backlight module according to claim 1, wherein each of the first LED devices comprises an LED chip and a reflective lens, both of which are packaged, and each of the second LED devices comprises an LED chip and a refractive lens, both of which are packaged.

4. The backlight module according to claim 3, wherein the reflective lenses comprise reflective glass lenses, reflective polycarbonate lenses, or reflective PMMA lenses; and the refractive lenses comprise refractive glass lenses, refractive polycarbonate lenses, or refractive PMMA lenses.

5. The backlight module according to claim 1, wherein the first LED devices are distributed uniformly, and the second LED devices are distributed uniformly.

6. The backlight module according to claim 2, wherein the first LED devices are distributed uniformly, and the second LED devices are distributed uniformly.

7. The backlight module according to claim 3, wherein the first LED devices are distributed uniformly, and the second LED devices are distributed uniformly.

8. The backlight module according to claim 4, wherein the first LED devices are distributed uniformly, and the second LED devices are distributed uniformly.

9. A display device, comprising a backlight module, wherein the backlight module comprises a back cover comprising an accommodation space in which a reflector, a light component, and a diffuser plate are placed in order, wherein:
the light component comprises a plurality of first Light Emitting Device (LED) devices and a plurality of second LED devices, wherein the second LED devices emit light at a smaller angle than the angle at which the first LED devices emit light, the first LED devices are arranged annularly and opposite the periphery area of the diffuser plate, and the second LED devices are located so that they are surrounded by the first LED devices.

10. The display device according to claim 9, wherein the display device comprises a liquid crystal TV set, a liquid crystal display, or a liquid crystal exhibition screen.

11. The display device according to claim 9, wherein each of the first LED devices emits light at an angle from 150° to 170°, and each of the second LED devices emits light at an angle from 90° to 120°.

12. The display device according to claim 9, wherein each of the first LED devices comprises an LED chip and a reflective lens, both of which are packaged, and each of the second LED devices comprises an LED chip and a refractive lens, both of which are packaged.

13. The display device according to claim 12, wherein the reflective lenses comprise reflective glass lenses, reflective polycarbonate lenses, or reflective PMMA lenses; and the refractive lenses comprise refractive glass lenses, refractive polycarbonate lenses, or refractive PMMA lenses.

14. The display device according to claim 9, wherein the first LED devices are distributed uniformly, and the second LED devices are distributed uniformly.

15. The display device according to claim 11, wherein the first LED devices are distributed uniformly, and the second LED devices are distributed uniformly.

16. The display device according to claim 12, wherein the first LED devices are distributed uniformly, and the second LED devices are distributed uniformly.

17. The display device according to claim 13, wherein the first LED devices are distributed uniformly, and the second LED devices are distributed uniformly.
